(19) United States
(12) Patent Application Publication
(10) Pub. No.: US 2016/0236096 A1
(43) Pub. Date: Aug. 18, 2016

(54) Wellness System For Interacting With A User

(71) Applicants: Michael TRZECIESKI, MID LEVELS (HK); Deo Dumaraos, Muntinlupa City (PH)

(72) Inventors: Michael TRZECIESKI, MID LEVELS (HK); Deo Dumaraos, Muntinlupa City (PH)

(21) Appl. No.: 14/622,859

(22) Filed: Feb. 14, 2015

(51) Int. Cl. A63F 13/825; A63F 13/537; A63F 13/212

(52) U.S. Cl. CPC A63F 13/825; A63F 13/212; A63F 13/537

(57) ABSTRACT

A wellness system for interacting with a user is provided where a virtual pet is provided as part of a smartphone application. The virtual pet is used to engage the user to perform activities such as drink water, eat, sleep and get exercise. Notification of the type of activity the user is to perform is visually provided on the smartphone. When the user complies they then increase their health score and thereby increase their general wellbeing.

### CROSS REFERENCE TO RELATED APPLICATION

This application benefits from the priority of U.S. Provisional Applications 61/939,742 filed on Feb. 14, 2014, which is incorporated herein by reference.

### TECHNICAL FIELD OF THE INVENTION

The technical field of the invention relates to health and wellness and more specifically to motivating to a user to improve their wellness.

### BACKGROUND OF THE INVENTION

Many people wish to have a healthier lifestyle but find it hard to stick with a health and wellness routine, they don't feel motivated to becoming healthier and also don't know how to fit in a healthy lifestyle into their daily routine. This means they usually end up sticking with their current state of wellness and this is typically below average.

User engagement and keeping users engaged isn't trivial. An example in the prior art that was a success for user engagement was the Tamagoutchi, a handheld digital virtual pet that millions of people played with. It features virtual characters based on animals, objects, or people. Tamagotchis are alien species that start off as an egg and it is a responsibility of a user to raise the egg into an adult creature. The creatures develop differently based on the care the user provides. With better sustenance provided to the Tamagoutchi by the user it ends up being smarter, happier, and requiring less attention as it developed.

Most health and wellness solutions on the market today fall short on interactive, engaging and motivational features that provide end user engagement. It is therefore an object of the invention to provide a wellness system for interacting with a user that overcomes the aforementioned deficiencies.

### SUMMARY OF THE INVENTION

In accordance with the embodiments of the invention there is provided a wellness system for interacting with a user comprising: a remote server comprising a memory circuit for storing at least an actionable plan data; a server processor comprising a first wireless transceiver and coupled with the remove server; a smartphone device comprising a processor for executing a smartphone application for receiving of the user input and the smartphone device comprising a display screen for being seen by the user for displaying a notification graphic and a virtual electronic pet graphic, the smartphone device comprising a user input area for receiving user input a second wireless transceiver for communicating with the first wireless transceiver for wirelessly receiving a sustenance data for graphically being depicted on the display screen as the virtual electronic pet graphic and for wirelessly transmitting a notification compliance data received from the user input area to the first wireless transceiver; the virtual electronic pet graphic comprising at least a first virtual electronic pet image and a second virtual electronic pet image; wherein one of the first virtual electronic pet image and the second virtual electronic pet image are displayed on the display screen in dependence upon the server processor processing the at least an actionable plan data and the notification compliance data to generate of the sustenance data.

In accordance with the embodiments of the invention there is provided a wellness system for interacting with a user comprising: providing a wellness team for engaging with the user; interviewing the user by the wellness team to determined an actionable plan data comprising a series of time based activities for the user to perform, the series of time based activities derived from hydrating and physical activity and resting and eating; providing a smartphone application for being executed by a smartphone device having a display screen, the smartphone application for receiving of input from the user; displaying a notification graphic for being viewed by the user on the display screen, the notification graphic representing one of the time based activities for being performed by the user; displaying a virtual electronic pet graphic for being viewed by the user on the display screen; engaging the user with the virtual electronic pet graphic through varying an animation thereof; measuring a time taken between the notification graphic being displayed to the user and receiving of notification compliance data from the user; mathematically combining the hydration data and activity data and rest data and nutrition data to generate a health score for the user; and, affecting a visual appearance of the virtual electronic pet graphic based on the measured time taken and the health score for the user.

### BRIEF DESCRIPTION OF THE DRAWINGS

FIG. 1A illustrates, a wellness system for interacting with a user (WS) in accordance with the embodiments of the invention;

FIG. 2A, a virtual electronic pet graphic that is displayed is either a first virtual electronic pet image or a second virtual electronic pet image is shown;

FIG. 2B illustrates an example of the first actionable plan data;

FIG. 2C illustrates various notification graphics;

FIG. 2D, illustrates notification being provided to the user in the form of a notification message;

FIG. 2E illustrates first through third virtual electronic pet images; and,

FIG. 3A illustrates the wellness system with its operational steps for interacting with the user.

### DETAILED DESCRIPTION OF EMBODIMENTS OF THE INVENTION

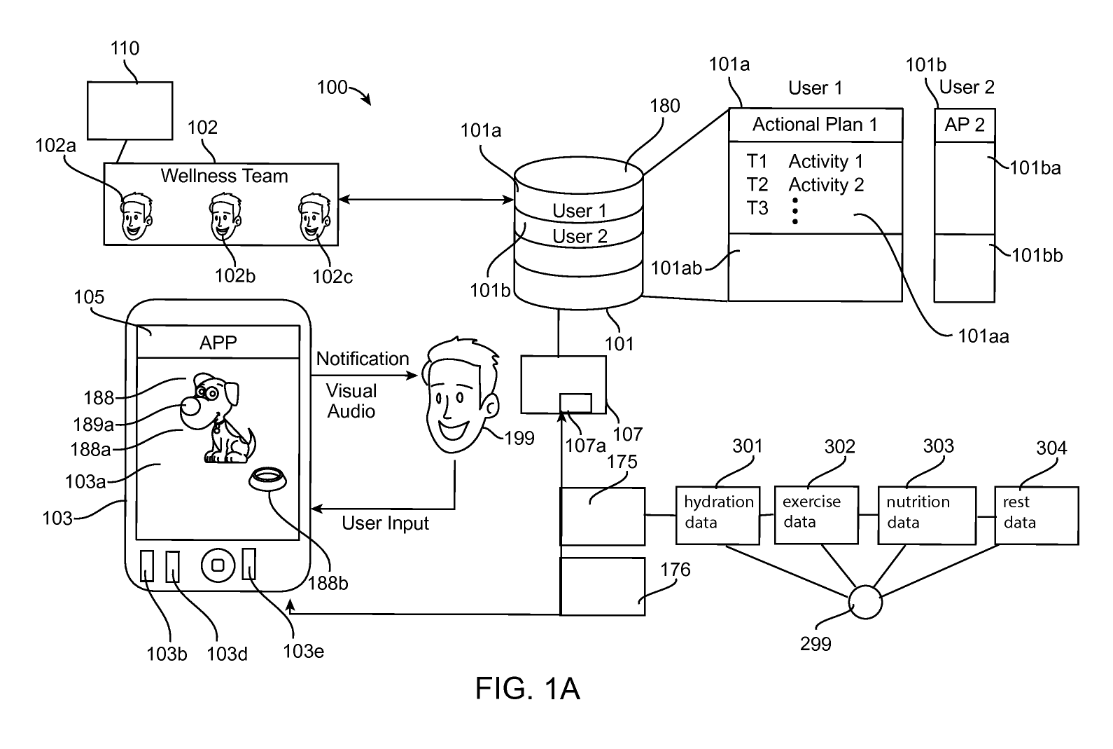

Referring to FIG. 1A, a wellness system for interacting with a user (WS) 100 in accordance with the embodiments of the invention is provided. The WS 100 is comprised of a remote server 101 comprising a memory circuit 180 for storing at least an actionable plan data 101a, 101b for a first user 199 and a second user (not shown), respectively.

A server processor 107 having a first wireless transceiver 107a and coupled with the remove server 101 is provided. In the WS 100 the user 199 interacts through a smartphone device 103 for receiving of input from the user 199. The smartphone device 103 comprising a processor 103e for executing a smartphone application (APP) 105 and the smartphone device 103 comprises a display screen 103a for being viewed by the user 199 for displaying a notification graphic 188b and a virtual electronic pet graphic 188a.

For communicating with the first wireless transceiver 107a the smartphone device 103 comprises a second wireless transceiver 103b for wirelessly receiving a sustenance data 175 for graphically being depicted on the display screen 103a as the virtual electronic pet graphic 188a and for wirelessly transmitting a notification compliance data 176 to the first wireless transceiver 107a.

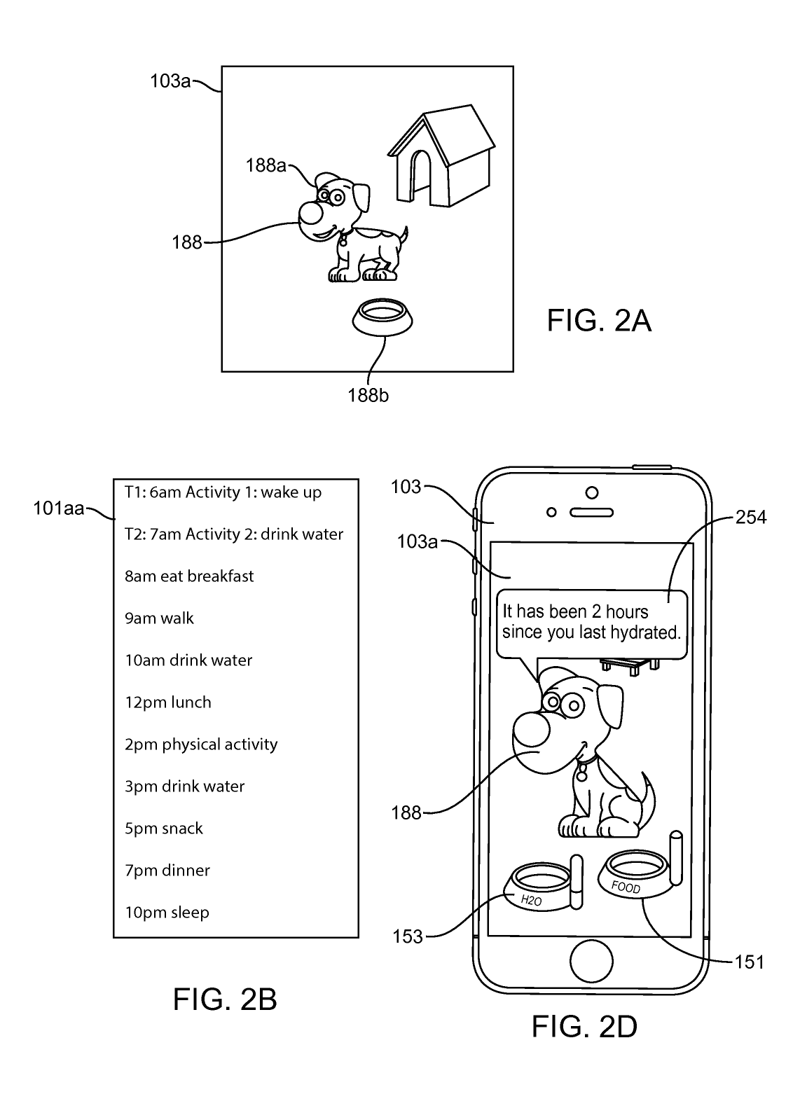

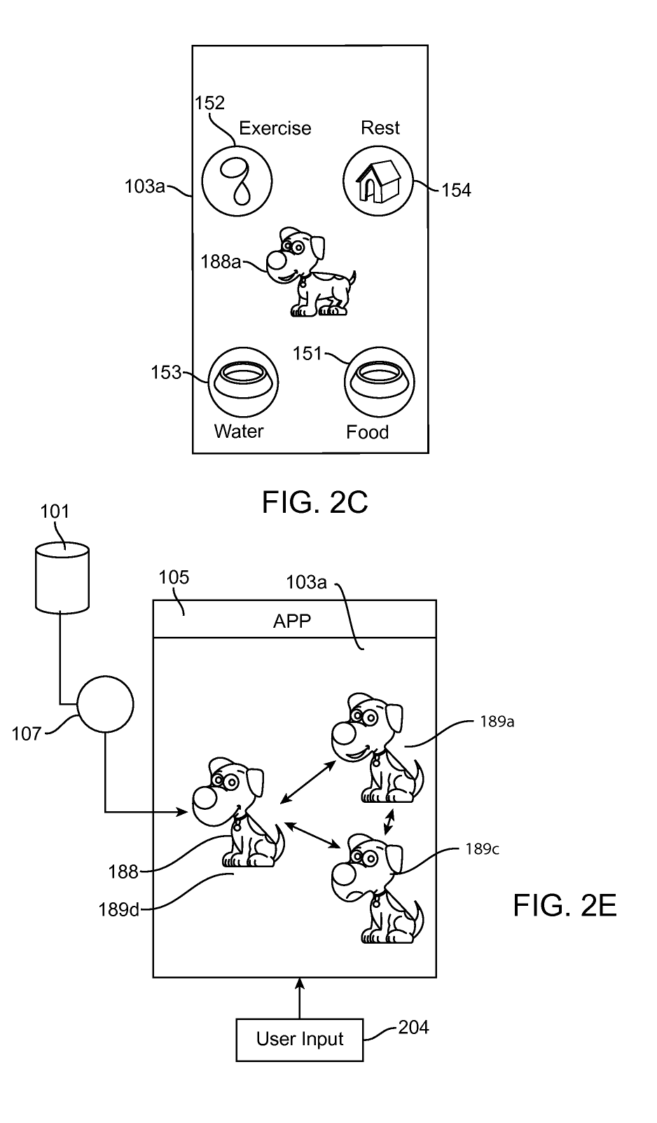

Referring to FIG. 2A, the virtual electronic pet graphic 188a that is displayed is either a first virtual electronic pet image 189a or a second virtual electronic pet image 189b. One of the first virtual electronic pet image and the second virtual electronic pet image are displayed on the display screen 103a in dependence upon the server processor 107a processing the at least an actionable plan data 101a and 101b and the notification compliance data 176 to generate of the sustenance data 175.

Referring to FIGS. 2A and 1B, the one of the at least a first virtual electronic pet image 189a and a second virtual electronic pet image 189b are other than a same image and comprise a visual representation of one of happy pet image, such as that indicated by 189a (FIG. 2E) and a third virtual electronic pet image 189c, that in this case represents a sad pet image (FIG. 2E) and a hungry pet image and a thirsty pet image and an angry pet image and an excited pet image and a pet image that is indicative of needing exercise, such as that indicated by 189b, the other images not shown.

Preferably the at least a first virtual electronic pet image 189a and a second virtual electronic pet image 189b as of an animal that is easily recognizable by the user 199 and that the user 199 can easily form a bond with. So for example an animal, such as a dog (as shown) a cat and a penguin and a bird and a fish.

Referring to FIG. 1A, a wellness team 102 is provided and includes at least a health coach (102a) that has access to a computer terminal 110 that is coupled with the remote server 101, the computer terminal 110 for receiving of the actionable plan data and the health coach 102a for communicating with the user 199 through the smartphone device 103 via the first wireless transceiver 107a and the second wireless transceiver 103b.

Referring to FIG. 2A, the notification graphic 188b is a graphic depiction of an action for the user 199 to observe in order to perform an action for obtaining of the notification compliance data 176, the action being for performing by the user 199 such as eating food as depicted by the notification graphic 188b, by showing an empty food bowl. Other activities may include performing a physical activity and drinking water and eating food and sleeping.

Referring to FIG. 1A, the at least an actionable plan data 101a, 101b comprises a first actionable plan data 101aa comprising a first plurality of time stamps as well as a first plurality of activities and a second actionable plan data 101ba comprising a second plurality of time stamps as well as a second plurality of activities. The first actionable plan data 101aa is a time based sequence of activities for the user 199 to perform, such as a first activity at a first time, Activity 1 being performed at a time T1, respectively and a second activity at a second time, Activity 2 for being performed at a time T2, respectively.

An example of the first actionable plan data 101aa is shown in FIG. 2B, where there is a plurality of time stamps as well as a plurality of activities, where each activity is tied to a unique time stamp as shown in this example: T1: 6 am and Activity 1: wake up, T2: 7 am Activity 2: drink water, 8 am eat breakfast, 9 am walk, 10 am drink water, 12 pm lunch, 2 pm physical activity, 3 pm drink water, 5 pm snack, 7 pm dinner and 10 pm sleep.

For interacting with the smartphone device 103 the user 199 provides user input in the form of tactile input, audio input and visual input, such as that from a camera. Most smartphone devices 103 comprise an accelerometer 103d also, wherein the accelerometer 103d is utilized for providing of the notification compliance data 176. Through using the accelerometer 103d when the user 199 goes for a walk with their phone in their pocket the accelerometer will register their steps and based on these steps the APP 105 will increment the exercise data 302.

Based on this initial contact with the user 199 and the wellness team 102, the wellness team 102 creates the first actionable plan data 101aa the user profile data 101ab and their interview. This first actionable plan data 101aa is a time based sequence of events and is meant to be a snapshot in the daily life of the user 199. The more complete the profile can be for the user 199 the better. It is the goal to understand the users 199 habits and likes and dislikes and medical conditions in order to provide as complete a user 199 profile as possible.

Referring to FIG. 2C, in order to simplify the interaction with the user in performing the time based sequence of events the notification graphic 188b is an exercise graphic 152, a drinking water graphic 151, a eating food graphic 153 and sleeping graphic 153. The virtual electronic pet graphic 188a is show on the screen 103a also for urging the user 199 to comply. For example when its time for the user 199 to drink water, the virtual electronic pet graphic 188a is such that the virtual pet is motioning towards the drinking water graphic 151, meaning its time for the user 199 to have some water. Once the user 199 has had their water, then they interact with the smartphone device 103 and click on the notification graphic 188b, in this case the drinking water graphic 151 and this generates compliance data that is then sent back to the remote server 101 and then processed to modify the sustenance data 175.

The sustenance data 175 is used for sustaining the “life” of the virtual pet 188 in the same manner in which sustaining the live of a real living pet would take place. Referring to FIG. 1A, the sustenance data 175 includes hydration data 301, exercise data 302, rest data 304 and nutrition data 303. Sustenance for the virtual pet 188 comes from the user 199 drinking water, performing exercise, eating their meals and taking their rest, respectively.

Each of the hydration data, 301 exercise data 302, rest data 304 and nutrition data 303 have a value from zero to ten, where ten means that the virtual pet 188 is optimally hydrated, optimally exercised, optimally rested and optimally fed and mathematically combining all of these data will generate a health score for the user. On the opposite extreme, a value of zero is indicative of dehydration, lethargic, insomniac and hungry, respectively. Drinking water increments the hydration data. Referring to FIG. 2D, notification to the user 199 is optionally provided as a notification message 254.

As for a real pet, the more sustenance that it receives (water, food, exercise and rest) the more lively the virtual pet 188 will be and as such the virtual pet 188 will appear more active on the display screen 103a. The less sustenance that is provided to the virtual pet the less lively the virtual pet appears on the display screen 103a.

For example when the user 199 goes for a walk, then the virtual pet is taken for a walk and the exercise data 302 is incremented, when the user 199 eats, the virtual pet 188 is fed and the nutrition data 303 is incremented giving the pet water is indicative of the user 199 drinking water and the hydration data 301 is incremented, and when the user 199 wakes up and goes to bed is shown as the pet getting enough sleep and this increments the rest data 304.

Decrementing of the hydration data 301, exercise data 302, rest data 304 and nutrition data 303 is performed by the processing the at least an actionable plan data and the notification compliance by the server processor 107.

Preferably the nutrition data 303 is derived from the user 199 taking a photo of their meal, this photo is then transmitted to the remote server 101 and the wellness team evaluates the picture and enters calories and breakdown of the food, for example the protein, fat, carbs, sugars and thereby populates the nutrition data 303.

Preferably the virtual pet graphic 188a is presented as a dog and is a direct representation of the wellness of the user 199. The more improved the wellness of the user 199 because they adhere to the actionable plan, the healthier in appearance will be the virtual pet 188. If the user isn't adhering to their actionable plan and providing compliance data within a timeframe when the notification graphic 188b appears, then the virtual pet appears to be lethargic and fat. The opposite is that when the user 199 is adhering to their actionable plan and providing compliance data, then the virtual pet 188 appears to be healthy and lively.

Based on the interaction the virtual pet 188 character is then generated for them based on their initial health and the sustenance data 175 is initially filled in. For example, if the user 199 is of average health, then the hydration data 301, exercise data 302, rest data 304 and nutrition data 303 have a value of five out of ten and the virtual pet 188 will appear to be average looking 189d and average size (not too fat or too skinny) and will have an average liveliness. The goal of the WS 100 in accordance with the embodiments of the invention is for the user 199 to improve their health to make their virtual per 188 more active and more lively and happier looking and younger appearing.

The age of the user 199 is irrelevant in this case and what is important is how they are acting in terms of their health and in complying with the notifications to generate the compliance data.

Over time, the wellness team 102 reviews the at least an actionable plan data 101a. If the user is not adhering to the WS 100, then a call results to them so they improve their adherence. The aim of the WS 100 is to have a healthy virtual pet 188 and in turn a healthy user 199 and for the virtual pet 188 to engage the user for compliance.

Referring to FIG. 2E, in order to provide personality to the virtual pet 188 and for the virtual pet 188 to take on its own “life”, the APP 105, is for receiving of the sustenance data and includes a state machine 202 as is know to those of skill in the art. The state machine 202 is for providing of the “life” to the virtual pet 188 and for making the virtual pet 188 to seem alive and to be acting on its own to engage the user 199 to provide compliance data in response to the notification data.

In addition there is provided a third virtual electronic pet image 189d, wherein the state machine 202 controls whether one of the first, second and third virtual electronic pet images, 189a, 189b, 189d is displayed in a series of animated sequences and comprises a plurality of additional virtual electronic pet images for being displayed for engaging of the user to provide notification compliance data within a predetermined amount of time after the notification graphic is displayed on the display screen for the user. The smartphone device 103 includes a user input area 204 for receiving input from the user 199.

The virtual pet 188 undergoes different stages of growth, as the user improves their adherence to the actionable plan and cooperates with the WS 100. The virtual pet 188, will appear to be skinnier, fatter, older, younger, more active as a puppy, depending on the compliance and actions of the user 199.

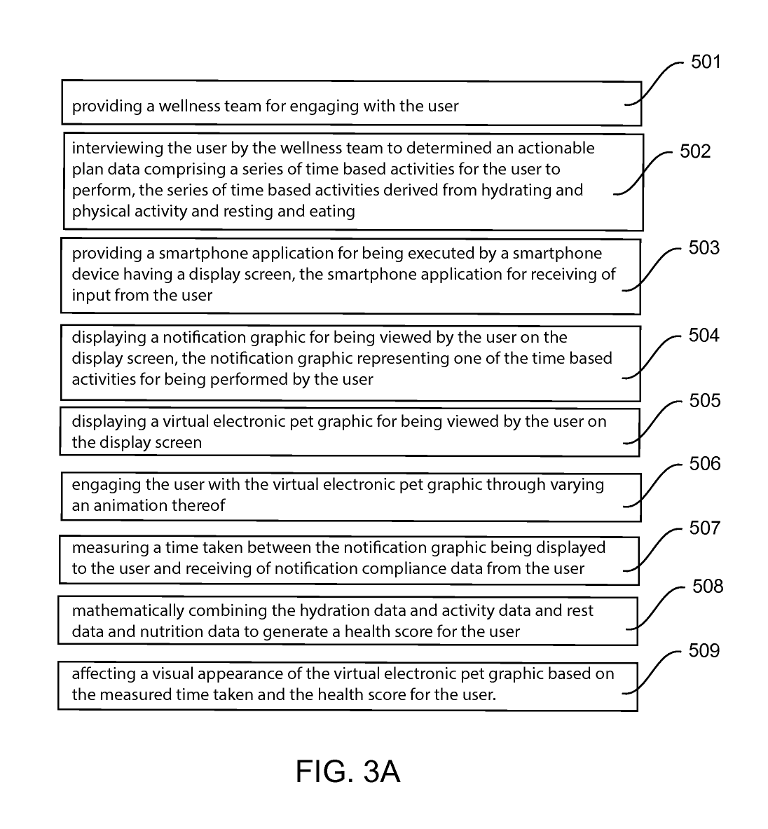

Referring to FIG. 3A, the wellness system 100 is illustrated in its operational steps for interacting with the user 199. A wellness team 102 is provided 501, the wellness team 102 interviews the user 199 to determined the actionable plan data 101a comprising a series of time based activities for the user to perform, the series of time based activities derived from hydrating and physical activity and resting and eating 502. In step 503, a smartphone application for being executed by a smartphone device 103 having a display screen 103a is provided, the smartphone application 105 for receiving of input from the user 199. In step 504 displaying a notification graphic 188b for being viewed by the user 199 on the display screen 103a is provided, the notification graphic 188b representing one of the time based activities for being performed by the user 199. Referring to step 505 displaying the virtual electronic pet graphic 188a for being viewed by the user on the display screen is performed and thereafter engaging the user with the virtual electronic pet graphic 188a through varying an animation thereof 506, takes place. In order to measure compliance, measuring a time taken between the notification graphic being displayed to the user 199 and receiving of notification compliance data from the user 199 takes place. Mathematically combining the hydration data 301 and activity data 302 and rest data 304 and nutrition data 303 to generate a health score 299 (FIG. 1A) for the user 199 is performed in step 508 affecting a visual appearance of the virtual electronic pet graphic 188a based on the measured time taken and the health score 299 for the user 199.

Advantageously, the virtual pet 188 as part of the WS 100 serves to engage the user 199 using the state machine 107, in this manner there are games that can be played with the virtual pet 188. Further advantageously, because the WS 100 utilizes a smartphone 103 its designed to be carried with the user 199 so that notifications are preferably administered whenever necessary. By representing the wellness of the user 199 using a virtual pet 188 it has been noted that the user 199 will take care of the virtual pet 188 and in turn take better care of themselves. The sustenance for the virtual pet is provided by the user 199 and their compliance to the notifications and the virtual pet 188 taking reference of its “life” to that of the Tamagotchi, as is well known in the prior art.

The virtual pet 188 is representative of the users health, the healthier the user 199 the happier the virtual pet 188 appears. Advantageously the goal of the embodiments of the invention is to provide the virtual pet 188 to engage the user 199 and for them to take care of the virtual pet 188 by taking care of themselves.

Numerous other embodiments may be envisaged without departing from the spirit or the scope of the invention.

What is claim is:

1. A wellness system for interacting with a user comprising:
a remote server comprising a memory circuit for storing at least an actionable plan data;
a server processor comprising a first wireless transceiver and coupled with the remove server;
a smartphone device comprising a processor for executing a smartphone application for receiving of the user input and the smartphone device comprising a display screen for being seen by the user for displaying a notification graphic and a virtual electronic pet graphic,
the smartphone device comprising a user input area for receiving user input a second wireless transceiver for communicating with the first wireless transceiver for wirelessly receiving a sustenance data for graphically being depicted on the display screen as the virtual electronic pet graphic and for wirelessly transmitting a notification compliance data received from the user input area to the first wireless transceiver;
the virtual electronic pet graphic comprising at least a first virtual electronic pet image and a second virtual electronic pet image;
wherein one of the first virtual electronic pet image and the second virtual electronic pet image are displayed on the display screen in dependence upon the server processor processing the at least an actionable plan data and the notification compliance data to generate of the sustenance data.

2. A wellness system for interacting with a user according to claim 1 wherein the smartphone application comprises a state machine for receiving the sustenance data and for receiving of the notification compliance data and for displaying one of the at least a first virtual electronic pet image and a second virtual electronic pet image on the display screen in dependence upon a state thereof.

3. A wellness system for interacting with a user according to claim 1 wherein the one of the at least a first virtual electronic pet image and a second virtual electronic pet image are other than a same image and comprise a visual representation of one of happy pet image and a sad pet image and a hungry pet image and a thirsty pet image and an angry pet image and an excited pet image and a pet image that is indicative of needing exercise.

4. A wellness system for interacting with a user according to claim 3 wherein the one of the at least a first virtual electronic pet image and a second virtual electronic pet image comprises one of a dog and a cat and a penguin and a bird and a fish.

5. A wellness system for interacting with a user according to claim 1 comprising a wellness team comprising at least a health coach and comprising a computer terminal for receiving of the actionable plan data and communicating with the user through the smartphone device.

6. A wellness system for interacting with a user according to claim 1 wherein the notification graphic is a graphic depiction of an action for the user to observe in order to perform an action for obtaining of the notification compliance data, the action being one of: performing a physical activity and drinking water and eating food and sleeping.

7. A wellness system for interacting with a user according to claim 1 wherein the smartphone device comprises an accelerometer sensor and wherein the notification compliance data comprises data derived from the accelerometer sensor.

8. A wellness system for interacting with a user according to claim 1 wherein the at least an actionable plan data comprises a first actionable plan data comprising a time based sequence of activities for the user to perform comprising a first activity for being performed at a first time and a second activity for being performed at a second time, wherein the first and second time are other than the same.

9. A wellness system for interacting with a user according to claim 1 wherein the user input provided to the user input area is one of tactile audio and visual.

10. A wellness system for interacting with a user according to claim 2 a third virtual electronic pet image, wherein the state machine controls whether one of the first, second and third virtual electronic pet image is displayed in a series of animated sequences and comprises a plurality of additional virtual electronic pet images for being displayed for engaging of the user to provide notification compliance data within a predetermined amount of time after the notification graphic is displayed on the display screen for the user.

11. A wellness system for interacting with a user according to claim 1 wherein the sustenance data is at least one of hydration data and activity data and rest data and nutrition data.

12. A wellness system for interacting with a user according to claim 1 wherein the wellness team comprises at least one of a nutritionist and a psychologist 102c and a fitness coach and a nurse.

13. A wellness system for interacting with a user according to claim 11 comprising mathematically combining hydration data and activity data and rest data and nutrition data to generate a health score for the user.

14. A wellness system for interacting with a user comprising:
providing a wellness team for engaging with the user;
interviewing the user by the wellness team to determined an actionable plan data comprising a series of time based activities for the user to perform, the series of time based activities derived from hydrating and physical activity and resting and eating;
providing a smartphone application for being executed by a smartphone device having a display screen, the smartphone application for receiving of input from the user;
displaying a notification graphic for being viewed by the user on the display screen, the notification graphic representing one of the time based activities for being performed by the user;
displaying a virtual electronic pet graphic for being viewed by the user on the display screen;
engaging the user with the virtual electronic pet graphic through varying an animation thereof;
measuring a time taken between the notification graphic being displayed to the user and receiving of notification compliance data from the user;
mathematically combining the hydration data and activity data and rest data and nutrition data to generate a health score for the user; and,
affecting a visual appearance of the virtual electronic pet graphic based on the measured time taken and the health score for the user.

15. A wellness system according to claim 14 comprising:
processing of the actionable plan data to generate sustenance data; and
providing the sustenance data to the smartphone application for use in displaying the notification graphic and the virtual electronic pet graphic.

16. A wellness system according to claim 14 comprising providing a predetermined amount of time for receiving of the notification compliance data from the user, wherein the health score is decremented when the time taken between the notification graphic being displayed to the user and receiving of notification compliance data from the user is more than the predetermined amount.

17. A wellness system according to claim 14 comprising providing a predetermined amount of time for receiving of the notification compliance data from the user, wherein the health score is incremented when the time taken between the notification graphic being displayed to the user and receiving of notification compliance data from the user is more than the predetermined amount.

18. A wellness system according to claim 16 wherein the wellness team comprises at least one of a nutritionist and a psychologist and a fitness coach and a nurse.

19. A wellness system according to claim 14 wherein the smartphone application comprises a state machine for receiving the sustenance data and for receiving of the notification compliance data and for affecting a visual appearance of the virtual electronic pet graphic by displaying one of at least a first virtual electronic pet image and a second virtual electronic pet image on the display screen in dependence upon a state thereof.

20. A wellness system according to claim 14 wherein the nutrition data is derived from the user taking a photo of their food and the photo is then transmitted to the remote server and the wellness team evaluates the photo and populates the nutrition data.
